(19) United States
(12) Patent Application Publication
(10) Pub. No.: US 2020/0361825 A1
(43) Pub. Date: Nov. 19, 2020

(54) GREEN CERAMIC BATCH MIXTURES COMPRISING AN INVERSE EMULSION AND METHODS FOR FORMING A CERAMIC BODY

(71) Applicant: Corning Incorporated, Corning, NY (US)

(72) Inventor: Mark Alan Lewis, Horseheads, NY (US)

(21) Appl. No.: 16/638,371

(22) PCT Filed: Aug. 8, 2018
(86) PCT No.: PCT/US2018/045711

§ 371 Date: Feb. 11, 2020

Related U.S. Application Data
(60) Provisional application No. 62/544,386, filed on Aug. 11, 2017.

(51) Int. Cl. C04B 35/195; C04B 35/636; C04B 35/634; C04B 35/626

(52) U.S. Cl. CPC C04B 35/195; C04B 35/6365; C04B 2235/6021; C04B 35/6264; C04B 2235/3218; C04B 35/63448

(57) ABSTRACT

Green ceramic batch mixtures include at least one inorganic batch component, at least one organic binder, and a water-in-oil emulsion including at least one lubricant, at least one aqueous solvent, and at least one emulsifier. Methods for forming ceramic bodies include forming a green ceramic batch mixture including a water-in-oil emulsion and extruding the green ceramic batch mixture. The methods and batch mixtures can be used to produce green and fired ceramic bodies.

This application claims the benefit of priority under 35 U.S.C. § 119 of U.S. Provisional Application Ser. No. 62/544,386, filed on Aug. 11, 2017, the content of which is relied upon and incorporated herein by reference in its entirety.

### FIELD OF THE DISCLOSURE

The disclosure relates generally to green ceramic batch materials comprising at least one extrusion aid. More specifically, the disclosure relates to green ceramic batch mixtures comprising a water-in-oil emulsion and methods for extruding such batch mixtures to form a green ceramic body, which can be fired into a ceramic body.

### BACKGROUND

Ceramic bodies, such as cordierite and aluminum titanate ceramics, may be used in a variety of applications. For example, ceramic bodies may be useful as filtration articles, e.g., catalytic converters and particulate filters, which can be utilized to remove pollutants and/or particulates from fluid streams. Exemplary fluid streams may comprise gases, vapors, or liquids, and the particulates may comprise a separate phase in the fluid, such as solid particulates in a gas or liquid stream, or droplets of liquid in a gas stream, and the like. Particulates can include soot, ash, dust, aerosolized liquids, and any other variety of particulate contaminant present in any given fluid. Pollutants can include toxic gases or liquids, e.g., carbon monoxide, unburned hydrocarbon fuel, and the like.

### SUMMARY

The disclosure relates, in various embodiments, to a green ceramic (ceramic or ceramic-forming) batch mixture comprising at least one inorganic batch component, at least one organic binder, and an inverse emulsion comprising at least one lubricant, at least one aqueous solvent, and at least one functionalized silicone compound. The disclosure also relates to a method for producing a green ceramic body, the method comprising mixing batch materials to form a green ceramic batch mixture, wherein the batch materials comprise at least one inorganic batch component, at least one organic binder, at least one lubricant, at least one aqueous solvent, and at least one functionalized silicone compound; forming an inverse emulsion in the green ceramic batch mixture, the inverse emulsion comprising the at least one lubricant, the at least one aqueous solvent, and the at least one functionalized silicone compound; and extruding the green ceramic batch mixture to form a green ceramic body. Green and sintered ceramic bodies formed by these methods are further disclosed herein.

According to various embodiments, the at least one inorganic batch component may comprise a cordierite-forming powder. The at least one organic binder may, in certain embodiments, be a water-soluble binder, such as a cellulosic binder. In non-limiting embodiments, the at least one lubricant may be chosen from mineral oils, poly alpha-olefins, and combinations thereof. According to certain embodiments, the at least one functionalized silicone compound can comprise at least one functional group chosen from hydroxyl, carboxyl, and hydroxyl-terminated ethylene oxide groups, or combinations thereof. For example, the functionalized silicone compound may be chosen from functionalized siloxanes. The green ceramic batch mixtures may further comprise at least one auxiliary emulsifier, such as a fatty acid and/or surfactant. In non-limiting embodiments, the at least one aqueous solvent may be water. The aqueous solvent may be present in the inverse emulsion in an amount ranging from about 75% to about 95% by weight based on the total weight of the inverse emulsion. The inverse emulsion may be formed by pre-mixing the lubricant, aqueous solvent, and functionalized silicone compound and subsequently mixing the inverse emulsion with the inorganic batch components and/or organic binder. In other embodiments, the inverse emulsion may be formed during mixing of the batch materials.

Further disclosed herein are green ceramic batch mixtures comprising at least one inorganic batch component; at least one organic binder; and an inverse emulsion comprising at least one lubricant, at least one emulsifier, and at least 75% by weight of at least one aqueous solvent. Still further disclosed herein are methods for producing a ceramic body, the methods comprising mixing batch materials to form a green ceramic batch mixture, wherein the batch materials comprise at least one inorganic batch component, at least one organic binder, at least one lubricant, at least one aqueous solvent, and at least one emulsifier; and forming an inverse emulsion in the green ceramic batch mixture, the inverse emulsion comprising the at least one lubricant, the at least one aqueous solvent, and the at least one emulsifier, wherein the at least one aqueous solvent comprises at least about 75% by weight of the inverse emulsion; and extruding the green ceramic batch mixture to form a green ceramic body, which can then be fired into a ceramic body. The at least one emulsifier can be chosen from fatty acids, surfactants, and combinations thereof and may be present in the green ceramic batch mixture in an amount ranging from about 0.1% to about 3% by weight relative to the total weight of the batch mixture.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and, together with the description, serve to explain the principles and operations of the disclosure.

### BRIEF DESCRIPTION OF THE DRAWINGS

The following detailed description can be further understood when read in conjunction with the following drawings in which:

FIGS. 1A-B illustrate different lubrication mechanisms for green ceramic batch mixtures in an extrusion apparatus;

FIG. 2 is a graphical plot illustrating wall drag as a function of extrusion velocity for exemplary green ceramic batch mixtures; and

FIG. 3 is a graphical plot illustrating initial pressure as a function of extrusion velocity for exemplary green ceramic batch mixtures.

### DETAILED DESCRIPTION

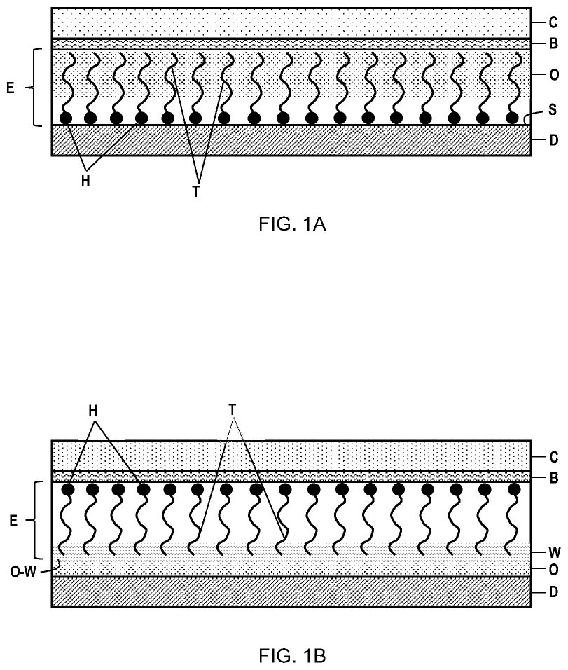

Referring to FIG. 1A, conventional theories pertaining to the lubrication mechanism for green ceramic batch mixtures in an extrusion apparatus hypothesize the migration of the emulsifier E from the green ceramic batch mixture C to the wall surface S such that the polar head group H of the emulsifier E attaches to the internal surface S of the extrusion apparatus D and the hydrophobic tail T interacts with the green ceramic batch mixture C and binder B via the oil phase O. However, it has now been surprisingly discovered that the lubrication mechanism instead involves interaction of the emulsifier E with the binder B at the oil-water O-W interface, as illustrated in FIG. 1B. Without wishing to be bound by theory, in light of this new understanding of the lubrication dynamic, it is believed that improved lubrication may be achieved by incorporating a water-in-oil (“inverse”) emulsion in the green ceramic batch mixture, e.g., such that the oil is the continuous phase the water is the dispersed phase.

Disclosed herein are green ceramic batch mixtures comprising at least one inorganic batch component, at least one organic binder, and an inverse emulsion comprising at least one lubricant, at least one aqueous solvent, and at least one functionalized silicone compound.

As used herein, the term “green ceramic batch mixture” and variations thereof is intended to denote a mixture comprising inorganic batch components capable of being formed into a green ceramic body, which can then be fired into a ceramic body, wherein the green ceramic batch mixture may comprise one or more ceramic components, and/or one or more components which are capable of forming a ceramic phase or ceramic material. The batch mixture may comprise a mixture of inorganic batch components and additional components, such as a binder, water, oil, and/or any other desired additive. In some embodiments, the mixture may be substantially homogeneous. Green ceramic batch-forming materials may have any suitable composition, e.g., as desired for a filtration application or any other application. Exemplary ceramic compositions include, but are not limited to, cordierite, aluminum titanate, silicon carbide, silicon nitride, calcium aluminate, zirconium phosphate, eucryptite, spodumene, mullite, feldspar, and the like. As such, in some embodiments, the green ceramic batch mixture may be a cordierite-forming batch mixture, an aluminum-titanate-forming batch mixture, and so forth, without limitation. According to certain embodiments, the inorganic batch components may be in the form of a reactive powder.

Inorganic batch components making up the green ceramic batch mixture may comprise one or more inorganic oxides or precursors thereof, collectively referred to herein as “source” materials. Sources may include, but are not limited to, materials that, when heated to a given temperature, alone or in the presence of other materials, will yield an inorganic oxide. In various non-limiting embodiments of the disclosure, inorganic batch components may comprise at least one source of alumina, silica, magnesia, titania, and/or other inorganic oxides (e.g., lanthanum, yttrium, barium, sodium, potassium, lithium, calcium, strontium, iron, boron, and phosphorous oxides), as well as other inorganic compounds such as carbonates, nitrates, and hydroxides (e.g., calcium and strontium carbonate).

Exemplary sources of alumina include, but are not limited to, alpha-alumina, transition aluminas such as gamma, theta, chi, and rho aluminas, hydrated alumina, gibbsite, corundum, boehmite, pseudoboehmite, aluminum hydroxide, aluminum oxyhydroxide, diaspore, kaolin, and combinations thereof. In various embodiments, the alumina source may be present in the green ceramic batch mixture in an amount ranging from about 25% to about 60% by weight, on an oxide basis, relative to the total weight of inorganic batch components. For example, the alumina source may comprise from about 30% to about 55%, from about 35% to about 50%, or from about 40% to about 45% by weight of the inorganic batch components, including all ranges and subranges therebetween.

Non-limiting examples of silica sources comprise non-crystalline silica, such as fused silica and sol-gel silica, crystalline silica such as zeolite, quartz, and cristobalite, colloidal silica, diatomaceous silica, silicone resin, diatomaceous silica, kaolin, talc, mullite, and combinations thereof. In other embodiments, the silica source may be chosen from silica-forming sources comprising at least one compound that forms silica when heated, such as, for example, silicic acid and silicone organometallic compounds. According to exemplary embodiments, the silica source may be present in the green ceramic batch mixture in an amount ranging from about 5% to about 60% by weight on an oxide basis, such as from about 8% to about 50%, from about 10% to about 40%, from about 12% to about 30%, or from about 15% to about 20% by weight on an oxide basis, relative to the total weight of the inorganic batch components, including all ranges and subranges therebetween.

Exemplary titania sources include, but are not limited to, rutile, anatase, amorphous titania, and combinations thereof. The titania source may be present in the green ceramic batch mixture in an amount ranging from about 25% to about 40% by weight on an oxide basis, such as from about 27% to about 35%, or from about 30% to about 33% by weight on an oxide basis, relative to the total weight of the inorganic batch components, including all ranges and subranges therebetween.

Non-limiting examples of magnesia sources comprise talc, magnesite, magnesium hydroxide, and combinations thereof. The magnesia source may be present in the green ceramic batch mixture in an amount ranging from about 5% to about 25% by weight on an oxide basis, such as from about 10% to about 20%, from about 12% to about 17%, or from about 14% to about 16% by weight on an oxide basis, relative to the total weight of the inorganic batch components, including all ranges and subranges therebetween.

The green ceramic batch mixture may, in some embodiments, further comprise at least one additional inorganic oxide, carbonate, nitrate, or hydroxide, such as lanthanum, yttrium, barium, sodium, potassium, lithium, calcium, strontium, iron, boron, and phosphorous oxides, carbonates, nitrates, and/or hydroxides. According to various embodiments, such additional components may be present in the green ceramic batch mixture in an amount ranging from about 3% to 50% by weight on an oxide basis, such as from about 5% to about 40%, from about 8% to about 30%, from about 10% to about 20%, or from about 12% to about 15% by weight on an oxide basis, relative to the total weight of the inorganic batch components, including all ranges and subranges therebetween. One or more multi-source inorganic compounds may also be included in the green ceramic batch mixture, e.g., a compound comprising more than one type of oxide or precursor thereof, such as kaolin.

In various embodiments, the inorganic batch components may be chosen such that the green ceramic batch mixture forms and/or comprises cordierite, aluminum titanate, silicon carbide, silicon nitride, calcium aluminate, zirconium phosphate, eucryptite, spudomene, mullite, and feldspar ceramic bodies. Thus, one or more inorganic components may have the same composition as the final fired composition, for example an inorganic component may be silicon carbide wherein silicon carbide particles bond, agglomerate, or sinter to one another resulting in a silicon carbide final ceramic body; or, one of the inorganic components may be cordierite wherein the final fired ceramic article comprises cordierite. Instead, or in addition, the inorganic components may comprise two or more inorganic components which react with each other in a solid phase reaction to result in a final fired composition which is different from either of the inorganic components, for example alumina and silica can be provided as inorganic components and the final fired ceramic composition may be cordierite or aluminum titanate or other composition. In at least one embodiment, the green ceramic batch mixture may form an aluminum titanate ceramic body. For instance, the stoichiometry of the inorganic batch components may be chosen to produce a ceramic composition comprising about 45-55 wt % alumina, about 25-35 wt % titania, and about 5-15 wt % silica. Exemplary aluminum titanate batch mixtures and the preparation thereof are described in U.S. Pat. Nos. 4,483,944, 4,855,265, 5,290,739, 6,620,751, 6,942,713, 6,849,181, 7,001,861, 7,259,120, and 7,294,164; U.S. Patent Application Publication Nos. 2004/0020846 and 2004/0092381; and International Patent Application Publication Nos. WO 2006/015240, WO 2005/046840, and WO 2004/011386, all of which are incorporated herein by reference in their entireties.

According to certain embodiments, the green ceramic batch mixture may form a cordierite-forming green ceramic body, which may then be fired into a cordierite ceramic body. For instance, the stoichiometry of the inorganic batch components may be chosen to produce a ceramic composition comprising about 35-60 wt % silica, about 25-50 wt % alumina, and about 5-25 wt % magnesia. Exemplary cordierite batch mixtures and the preparation thereof are described in U.S. Pat. No. 7,704,296 and U.S. Patent Application Publication No. 2009/0220736, both of which are incorporated herein by reference in their entireties. The cordierite green ceramic composition may, in various exemplary embodiments, comprise clay or may, in other embodiments, be substantially free of clay. For example, the cordierite batch mixtures may comprise less than about 1% by weight of clay, for example, less than about 0.5% by weight of clay, or less than about 0.1% by weight of clay.

The green ceramic batch mixtures may, in various embodiments, comprise at least one organic binder, such as a water-soluble binder. By way of non-limiting example, organic binders may comprise cellulosic binders such as methylcellulose, hydroxypropyl methylcellulose, methylcellulose derivatives, and combinations thereof. Commercially available cellulose binders may include, but are not limited to, Methocel binders sold by Dow Chemical. In certain embodiments, the at least one binder may be present in the green ceramic batch mixture in an amount ranging from about 1% to about 10% by weight, for example, from about 2% to about 6%, or about 3% to about 5%, by weight, relative to the total weight of the batch mixture.

In various embodiments, the green ceramic batch mixtures can further comprise at least one lubricant. For example, the green ceramic batch mixture may comprise at least one of mineral oil, corn oil, high molecular weight polybutenes, polyol esters, paraffin wax, and combinations thereof. In various embodiments, the at least one lubricant comprises a mineral or poly alpha-olefin oil. Commercially available lubricants can include, but are not limited to, Durasyn® products sold by Ineos, e.g., Durasyn® 162, and NEXBASE® 3020 sold by Neste. The at least one lubricant may be present in the green ceramic batch mixture in an amount ranging from about 1% to about 10% by weight, such as from about 2% to about 9%, from about 3% to about 8%, from about 4% to about 7%, or from about 5% to about 6% by weight, relative to the total weight of the batch mixture, including all ranges and subranges therebetween. In certain embodiments, the at least one lubricant may be present in the green ceramic batch mixture in an amount ranging from about 2% to about 5% by weight, relative to the total weight of the batch mixture.

At least one aqueous solvent comprising water may also be included in the green ceramic batch mixture. The aqueous solvent may comprise water alone or mixtures of water and at least one water-miscible solvent, e.g., alcohols. In at least one embodiment, the aqueous solvent consists essentially of water, such as deionized water. In various non-limiting embodiments, the at least one aqueous solvent may be present in the green ceramic batch mixture in an amount ranging from about 15% to about 50% by weight, such as from about 20% to about 45%, from about 25% to about 40%, or from about 30% to about 35% by weight, relative to the total weight of the batch mixture, including all ranges and subranges therebetween. According to certain embodiments, the at least one aqueous solvent may be present in the green ceramic batch mixture in an amount ranging from about 25% to about 40% by weight, relative to the total weight of the batch mixture.

The green ceramic batch mixture may further comprise at least one emulsifier. Exemplary emulsifiers comprise functionalized silicone compounds, such as functionalized siloxanes. Exemplary functional groups can include, but are not limited to, hydroxyl (OH), carboxyl (COOH), and hydroxyl-terminated ethylene oxide (EO)ₚOH groups, or combinations thereof. For instance, the functionalized silicone compound may be chosen from compounds of formula (I):

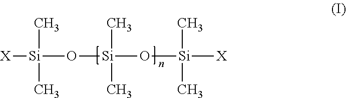

wherein n can range from 1 to 70, such as from 2 to 60, from 3 to 50, from 4 to 40, from 5 to 30, from 6 to 20, from 7 to 10, or from 8 to 9, including all ranges and subranges therebetween, and wherein X is a functional group, e.g., a hydroxyl group, a carboxyl group, or a hydroxyl-terminated ethylene oxide group. While the compounds of formula (I) are illustrated as bidentate compounds, it is also possible to utilize monodentate silicone compounds, e.g., compounds substituted with only one functional group X. Exemplary functionalized siloxane compounds can comprise compounds of formulae (II)-(IV):

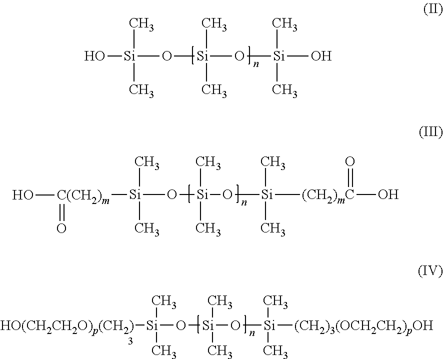

wherein n is as defined above, m ranges from 1 to 15, such as from 2 to 12, from 3 to 10, from 4 to 9, from 5 to 8, or from 6 to 7, including all ranges and subranges therebetween, and p ranges from 1 to 4, such as from 2 to 3, including all ranges and subranges therebetween. Monodentate silicone compounds comprising the functional groups depicted in formulae (II)-(IV) may also be used in some embodiments.

According to various embodiments, functional group X may comprise a hydrocarbon chain and at least one hydroxyl group. The hydrocarbon chain may, in non-limiting embodiments, comprise 15 carbon atoms or less, such as C₁-C₁₅ carbon chains, C₂-C₁₂ carbon chains, C₃-C₁₀ carbon chains, C₄-C₉ carbon chains, C₅-C₈ carbon chains, or C₆-C₇ carbon chains. The hydrocarbon chain may be saturated or unsaturated, linear, branched, or cyclic, and/or unsubstituted or substituted with at least one heteroatom, such as N, O, or S. The at least one functionalized silicone compound may be present in the green ceramic batch mixture in an amount ranging from about 0.05% to about 3% by weight, such as from about 0.1% to about 2.5%, from about 0.5% to about 2%, or from about 1% to about 1.5% by weight, relative to the total weight of the batch mixture, including all ranges and subranges therebetween. In some embodiments, the at least one functionalized silicone compound may be present in the green ceramic batch mixture in an amount ranging from about 0.1% to about 0.8% by weight, relative to the total weight of the batch mixture.

Extrusion aids can include oils, such as paraffin oils, which can be combined with one or more emulsifiers, such as fatty acids, which are believed to provide a “slip” layer between the green ceramic batch mixture and the extrusion equipment walls. Extrusion aids may reduce pressure within the extrusion equipment and allow for a higher feed rate and/or extrusion rate to increase production. The functionalized silicone emulsifiers disclosed herein may have one or more benefits as compared to traditional fatty acids and/or surfactants. Fatty acid emulsifiers often comprise a long hydrophobic carbon chain that may produce one or more problematic exotherms due to organic combustion when the green ceramic body is subsequently fired and/or these organic additives may undesirably volatilize during drying of the green ceramic body. The functionalized silicones disclosed herein may not volatilize during drying of the green ceramic body and/or may not produce a large exotherm due to organic combustion upon firing of the green ceramic body. Additionally, the functionalized silicone may serve as a bimodal additive, e.g., serving two purposes, first as an emulsifier and second as an inorganic source material upon its conversion to silica during firing of the green ceramic body.

The lubricant, aqueous solvent, and functionalized silicone compound may, in various embodiments, be present in the green ceramic batch mixture in the form of an inverse (water-in-oil) emulsion. As such, the relative amounts of each of these components on a weight basis relative to the total weight of the inverse emulsion may vary. Relative amounts within the inverse emulsion are calculated based on the assumption that each of the lubricant, aqueous, and emulsifier components fully (100%) participate in the inverse emulsion, but it is to be understood that portions of each of these components may be present outside of the emulsion, e.g., intermixed with the inorganic batch components and/or the binder, or any other component present in the batch mixture.

The at least one lubricant may be present in the inverse emulsion in an amount ranging from about 3% to about 30% by weight, such as from about 4% to about 25%, from about 5% to about 20%, or from about 10% to about 15% by weight, relative to the total weight of the inverse emulsion, including all ranges and subranges therebetween. The at least one aqueous solvent may be present in the inverse emulsion in an amount of at least about 75%, such as ranging from about 75% to about 95% by weight, from about 80% to about 92%, from about 82% to about 90%, or from about 85% to about 88% by weight, relative to the total weight of the inverse emulsion, including all ranges and subranges therebetween. The at least one functionalized silicone compound may be present in the inverse emulsion in an amount ranging from about 0.1% to about 10% by weight, such as from about 0.2% to about 9%, from about 0.3% to about 8%, from about 0.5% to about 7%, from about 1% to about 6%, from about 2% to about 5%, or from about 3% to about 4% by weight, relative to the total weight of the inverse emulsion, including all ranges and subranges therebetween. In certain embodiments, the at least one lubricant may be present in the inverse emulsion in an amount ranging from about 4% to about 12% by weight, the at least one aqueous solvent may be present in the inverse emulsion in an amount ranging from about 80% to about 90% by weight, and the at least one functionalized silicone compound may be present in the inverse emulsion in an amount ranging from about 0.2% to about 4% by weight, relative to the total weight of the inverse emulsion.

The green ceramic batch mixture may optionally comprise at least one additive, such as auxiliary emulsifiers, pore formers, and the like. Exemplary auxiliary emulsifiers can comprise fatty acids, surfactants, and other like compounds. Fatty acids may comprise saturated and unsaturated, linear and branched fatty acids, such as C₈-C₂₂ fatty acids and derivatives thereof, e.g., stearic acid, lauric acid, oleic acid, linoleic acid, and palmitoleic acid. Other exemplary fatty acids comprise tall oil, olean white, palmitic acid, and mixtures of fatty acids, such as mixtures comprising lauric acid, mixtures comprising oleic acid, and mixtures comprising stearic acid, such as Emersol® 213 (E213) and Emersol® 120 (E120). Mixtures of fatty acids and esters may also be used in some embodiments. The at least one fatty acid may be present in the green ceramic batch mixture in an amount ranging from about 0.1% to about 3% by weight, such as from about 0.3% to about 2.5%, from about 0.5% to about 2% by weight, or from about 1% to about 1.5% by weight, relative to the total weight of the batch mixture, including all ranges and subranges therebetween. In certain embodiments, the at least one fatty acid may be present in the green ceramic batch mixture in an amount ranging from about 0.1% to about 1% by weight, relative to the total weight of the batch mixture.

Non-limiting examples of surfactants comprise C₈-C₂₂ fatty alcohols, sulfates, esters, ethers, ethylene oxides, and combinations thereof. In certain embodiments, the at least one surfactant may be chosen from ammonium lauryl sulfate, polyethylene glycol alkyl ethers, sorbitan esters, ethoxylated sorbitan esters, polysorbates, ethylene oxides, and combinations thereof. According to non-limiting embodiments, the at least one surfactant may be chosen from non-ionic surfactants. Commercially available surfactants include, but are not limited to, Brij®, Span®, and Tween surfactants, e.g., Brij® 30, 35, 93, 97, and 98; Span® 20, 40, 60, 80, 83, 85, and 120; and Tween 20, 21, 40, 60, 61, 65, and 80. The at least one surfactant may be present in the green ceramic batch mixture in an amount ranging from about 0.05% to about 3% by weight, such as from about 0.1% to about 2.5%, from about 0.5% to about 2%, or from about 1% to about 1.5% by weight, relative to the total weight of the batch mixture, including all ranges and subranges therebetween. In certain embodiments, the at least one surfactant may be present in the green ceramic batch mixture in an amount ranging from about 0.1% to about 0.8% by weight, relative to the total weight of the batch mixture.

Exemplary pore formers may comprise, for instance, any particulate substance that burns out of the ceramic green body during firing to create pores in the fired ceramic body. Examples of pore formers include, but are not limited to, carbon pore formers, such as graphite, activated carbon, petroleum coke, and carbon black; starch pore formers, such as corn, barley, bean, potato rice, tapioca, pea, sago palm, wheat, canna, and walnut shell flours; polymer pore formers, such as polybutylene, polymethylpentene, polyethylene, polypropylene, polystyrene, polyamides (nylons), epoxies, ABS, acrylics, and polyesters (PET); and combinations thereof. According to at least one embodiment, the at least one pore former is chosen from carbon pore formers such as graphite and starch pore formers such as rice corn, sago palm, and potato. In various non-limiting embodiments, the at least one pore former may be present in the green ceramic batch mixture in an amount ranging from about 1% to about 40% by weight, for example, from about 5% to about 30%, from about 10% to about 25%, or from about 15% to about 20% by weight, relative to the total weight of the batch mixture, including all ranges and subranges therebetween. In certain embodiments, the green ceramic batch mixture may comprise two or more types of pore formers, such as three or more pore formers. For example, a combination of polymer and carbon pore formers, a combination of carbon and starch pore formers, or a combination of polymer and starch pore formers may be used, without limitation.

Also disclosed herein are green ceramic batch mixtures comprising at least one inorganic batch component; at least one organic binder; and an inverse emulsion comprising at least one lubricant, at least one emulsifier, and at least 75% by weight of at least one aqueous solvent. The emulsifier is, in some embodiments, chosen from one or more of the functionalized silicone compounds disclosed herein. In other embodiments, the emulsifier is chosen from the auxiliary emulsifiers disclosed herein, such as fatty acids, surfactants, and mixtures thereof. Mixtures of functionalized silicone compounds, fatty acids, and/or surfactants may also be used in some embodiments.

According to non-limiting embodiments, the at least one lubricant may be present in the green ceramic batch mixture in an amount ranging from about 1% to about 10% by weight, such as from about 2% to about 9%, from about 3% to about 8%, from about 4% to about 7%, or from about 5% to about 6% by weight, relative to the total weight of the batch mixture, including all ranges and subranges therebetween. In additional embodiments, the aqueous solvent may be present in the green ceramic batch mixture in an amount ranging from about 15% to about 50% by weight, such as from about 20% to about 45%, from about 25% to about 40%, or from about 30% to about 35% by weight, relative to the total weight of the batch mixture, including all ranges and subranges therebetween. According to further embodiments, the at least one emulsifier may be present in the green ceramic batch mixture in an amount ranging from about 0.05% to about 3% by weight, such as from about 0.1% to about 2.5%, from about 0.5% to about 2%, or from about 1% to about 1.5% by weight, relative to the total weight of the batch mixture, including all ranges and subranges therebetween. In certain embodiments, the at least one lubricant may be present in the green ceramic batch mixture in an amount ranging from about 2% to about 5% by weight, the at least one aqueous solvent may be present in the green ceramic batch mixture in an amount ranging from about 25% to about 40% by weight, and the at least one emulsifier may be present in the green ceramic batch mixture in an amount ranging from about 0.1% to about 0.8% by weight, relative to the total weight of the batch mixture.

In still further embodiments, the at least one lubricant may be present in the inverse emulsion in an amount ranging from about 3% to about 30% by weight, such as from about 4% to about 25%, from about 5% to about 20%, or from about 10% to about 15% by weight, relative to the total weight of the inverse emulsion, including all ranges and subranges therebetween. According to certain embodiments, the at least one aqueous solvent may be present in the inverse emulsion in an amount of at least about 75%, such as ranging from about 75% to about 95% by weight, from about 80% to about 92%, from about 82% to about 90%, or from about 85% to about 88% by weight, relative to the total weight of the inverse emulsion, including all ranges and subranges therebetween. In various embodiments, the at least one emulsifier may be present in the inverse emulsion in an amount ranging from about 0.1% to about 10% by weight, such as from about 0.5% to about 9%, from about 1% to about 8%, from about 2% to about 7%, from about 3% to about 6%, or from about 4% to about 5%, including all ranges and subranges therebetween. In certain embodiments, the at least one lubricant may be present in the inverse emulsion in an amount ranging from about 4% to about 12% by weight, the at least one aqueous solvent may be present in the inverse emulsion in an amount ranging from about 80% to about 90%, and the at least one emulsifier may be present in the inverse emulsion in an amount ranging from about 0.2% to about 4% by weight, relative to the total weight of the inverse emulsion.

According to non-limiting embodiments, the inverse emulsion can comprise a relatively high aqueous fraction, such as at least about 75% or more by weight of at least one aqueous solvent, e.g., water. The aqueous fraction can be adjusted by the type and/or amount of emulsifier used. The aqueous fraction can also be adjusted by one or more process parameters, such as extrusion temperature, pressure, and the like. Without wishing to be bound by theory, it is believed that a large aqueous fraction may advantageously solubilize the binder and result in a more effective lubrication mechanism. By selecting the appropriate emulsifier and its amount and, optionally, by adjusting one or more process parameters, the amount of aqueous solvent can be increased to greater than about 75% by weight while still maintaining the emulsion in an inverted state, e.g., with oil as the continuous phase and the aqueous solvent as the dispersed phase.

The disclosure also relates to methods for producing a ceramic body, the methods comprising mixing batch materials to form a green ceramic batch mixture, wherein the batch materials comprise at least one inorganic batch component, at least one organic binder, at least one lubricant, at least one aqueous solvent, and at least one functionalized silicone compound; forming an inverse emulsion in the green ceramic batch mixture, the inverse emulsion comprising the at least one lubricant, the at least one aqueous solvent, and the at least one functionalized silicone compound; and extruding the green ceramic batch mixture to form a green ceramic body.

Further disclosed herein are methods for producing a ceramic body, the methods comprising mixing batch materials to form a green ceramic batch mixture, wherein the batch materials comprise at least one inorganic batch component, at least one organic binder, at least one lubricant, at least one aqueous solvent, and at least one emulsifier; and forming an inverse emulsion in the green ceramic batch mixture, the inverse emulsion comprising the at least one lubricant, the at least one aqueous solvent, and the at least one emulsifier, wherein the at least one aqueous solvent comprises at least about 75% by weight of the inverse emulsion; and extruding the green ceramic batch mixture to form a green ceramic body.

The batch materials may be mixed using any suitable method known in the art. In various embodiments, the inorganic batch components may comprise dry powders, which can be mixed to form a substantially homogeneous dry mixture. For example, the inorganic batch components may be pre-combined to form a substantially dry mixture and may be subsequently wet and/or plasticized by the addition of one or more of the lubricant, solvent, binder, and/or emulsifier. Optionally, the at least one pore former may also be blended with the inorganic batch components to form a dry mixture. According to certain non-limiting embodiments, the lubricant, solvent, and emulsifier may be pre-mixed to form an inverse emulsion that is subsequently combined with the dry materials, e.g., the inorganic batch components and/or pore former. Alternatively, all wet and dry batch materials may be mixed together, in any order or sub-combination, to form a green ceramic batch mixture comprising the inverse emulsion, e.g., the inverse emulsion may be formed in situ during mixing. The individual components of the green ceramic batch mixture, regardless of the order of addition, may be mixed to form a substantially homogeneous mixture. By way of non-limiting example, the batch materials may be mixed or kneaded, e.g., using a ribbon mixer, twin-screw extruder/mixer, auger mixer, muller mixer, or double-arm mixer.

The green ceramic batch mixture may then be extruded to form a green ceramic body, such as a self-supporting green ceramic body. For instance, the green ceramic batch mixture may be extruded, e.g., vertically or horizontally, using a hydraulic ram extrusion press, a single auger extruder, or a twin-screw mixer, with a die assembly attached to the discharge end. According to various embodiments, the green ceramic batch mixture may be extruded to form a ceramic green body comprising a honeycomb configuration comprising a plurality of walls forming channels having one or more desired channel shapes, wall thicknesses, and/or cell densities.

As used herein, the term “green body” and variations thereof is intended to denote an unfired and, in some embodiments, an unreacted precursor composition or mixture, which can be extruded and, in various embodiments, can result in a self-standing green body after extrusion, such as is obtained by the mixture being plasticized. The green body may be dried and, in some embodiments, has not undergone calcination, sintering, or any other reactive process. In certain embodiments, the green body may optionally be dried using air drying, hot-air drying, dielectric drying, microwave drying, vacuum drying, or freeze drying. In contrast, a “fired” or “sintered” ceramic body and variations thereof is intended to denote a ceramic body that has undergone firing in conditions effective to convert the batch mixture into a final ceramic composition. The ceramic body may also undergo calcination during the firing process.

The green body may, in some embodiments, be fired to form a ceramic body. It is within the ability of those skilled in the art to determine the appropriate methods and parameters for forming the desired ceramic body, such as firing conditions including equipment, temperature, and duration. Such methods and conditions may depend, for example, on the size, geometry, and composition of the green body, as well as the desired properties of the ceramic body. By way of non-limiting example, firing may occur at a temperature ranging from about 1200° C. to about 1600° C., such as from about 1250° C. to about 1500° C., from about 1300° C. to about 1450° C., or from about 1350° C. to about 1400° C., including all ranges and subranges therebetween. Exemplary firing times may range from about 1 hour to about 200 hours, such as from about 2 hours to about 100 hours, from about 3 hours to about 50 hours, from about 5 hours to about 25 hours, or from about 10 hours to about 20 hours, including all ranges and subranges therebetween.

Optionally, the green ceramic body may be fired in a two-stage process, comprising a heating stage to burn out organic components such as the pore former, binder, surfactant, oil, and/or emulsifier. For instance, the binder may have a combustion temperature ranging from about 200° C. to about 300° C. and the pore former may have a combustion temperature ranging from about 300° C. to about 1000° C. During the heating stage, the green ceramic may be exposed to a temperature ranging from about 200° C. to about 1000° C., such as from about 300° C. to about 800° C., from about 400° C. to about 700° C., or from about 500° C. to about 600° C., including all ranges and subranges therebetween.

Ceramic bodies made using the methods and/or batch mixtures disclosed herein may be utilized to form a green ceramic body of a desired shape and/or dimension, including cellular bodies such as honeycomb bodies. For example, the batch mixtures disclosed herein can be extruded or otherwise formed to produce a green ceramic body having any shape, such as a honeycomb-shaped body. For example, a green ceramic body can have a 3-dimensional shape, such as a cube, block, pyramid, cylinder, sphere, or the like, with a width, length, height, and/or diameter. In various embodiments, the green ceramic body may be formed as a monolithic structure, for example, via extruding and/or molding techniques. Those having ordinary skill in the art are familiar with the various techniques for forming such ceramic monolithic structures. The green ceramic body may be subsequently fired to produce a fired ceramic body having the desired shape and composition.

In some embodiments, a sintered ceramic body or fired ceramic body can comprise a porous ceramic structure (or microstructure). A “porous” ceramic as disclosed herein can comprising a ceramic structure having a porosity, in some embodiments, of at least about 40%, such as about 45%, 50%, 55%, 60%, 65%, 70%, 75%, 80%, 85%, or greater. The porous ceramic structure is not limited in shape, size, pore size, pore distribution, and/or pore number. Porous ceramic structures may also have any variety of configurations and designs including, but not limited to, flow-through monolith, wall-flow monolith, or partial-flow monolith structures. Exemplary flow-through monoliths comprise walls forming channels, porous networks, or other passages through which fluid can flow from one end of the structure to the other. Exemplary wall-flow monoliths comprise, for example, walls forming channels or porous networks or other passages which may be open or plugged at opposite ends of the structure, thereby capable of directing fluid flow through the channel walls as it flows from one end of the structure to the other. Exemplary partial-flow monoliths can comprise a combination of a wall-flow monolith with a flow-through monolith, e.g., having some channels or passages open on both ends to permit some of the fluid to flow through the channel with minimal resistance. Segmented structures are also contemplated herein which can comprise two or more honeycomb blocks joined together, wherein each honeycomb block is a separate monolith.

In certain embodiments, the green or fired ceramic body has a honeycomb shape, e.g., comprising a plurality of walls forming parallel channels or cells. The cellular geometry of the honeycomb configuration is often used for filtration due to its high surface area per unit volume, such as for increased deposition of particulate matter. The honeycomb structure can comprise a plurality of interior walls separating and defining the plurality of channels. Additionally, one or more of the channels can comprise plugs, which can be used to direct or increase fluid flow through the interior channel walls. The honeycomb channels may have a substantially quadrilateral or hexagonal cross-section or can have any other suitable geometry, for example, circular, square, triangular, rectangular, or sinusoidal cross-sections, or any combination thereof.

Honeycomb bodies are often described in terms of cells (or channels) per square inch of surface area, as well as interior wall thickness (typically in mils or 10⁻³ inches). For example, a honeycomb body comprising 300 cells/in² and a wall thickness of 0.008 inches would be labeled as a 300/8 honeycomb, and so forth. Exemplary honeycomb bodies may comprise from about 100 to about 500 cells/in² (15.5-77.5 cells/cm²), such as from about 150 to about 400 cells/in² (23.25-62 cells/cm²), or from about 200 to about 300 cells/in² (31-46.5 cells/cm²), including all ranges and subranges therebetween. According to additional embodiments, the interior wall thickness can range from about 0.005 to about 0.02 inches (127-508 microns), such as from about 0.006 to about 0.015 inches (152-381 microns), from about 0.007 to about 0.012 inches (177-305 microns), or from about 0.008 to about 0.01 inches (203-254 microns), e.g., about 5×10⁻³, 6×10⁻³, 7×10⁻³, 8×10⁻³, 9×10⁻³, 10×10⁻³, 12×10⁻³, 14×10⁻³, 16×10⁻³, 18×10⁻³, or 20×10⁻³ inches, including all ranges and subranges therebetwen.

Typical honeycomb lengths and/or diameters can range from one to several inches, such as from about 1 inch to about 12 inches (2.54-30.48 cm), from about 2 inches to about 11 inches (5.08-27.94 cm), from about 3 inches to about 10 inches (7.62-25.4 cm), from about 4 inches to about 9 inches (10.16-22.86 cm), from about 5 inches to about 8 inches (12.7-20.32 cm), or from about 6 inches to about 7 inches (15.24-17.78 cm), including all ranges and subranges therebetween. The total volume of such honeycomb bodies can range, in some embodiments, from about 0.1 L to about 20 L, such as from about 0.5 L to about 18 L, from about 1 L to about 16 L, from about 2 L to about 14 L, from about 3 L to about 12 L, from about 4 L to about 10 L, or from about 5 L to about 8 L, including all ranges and subranges therebetween.

The green and/or sintered ceramic body may, in certain embodiments, comprise an outer skin and an interior core. For example, the outer skin can form a porous outer surface of the filter and the interior core can comprise walls defining a porous microstructure (e.g., a plurality of channels). The material forming the outer skin and interior walls may be the same or different and, in some embodiments, the outer skin may have a thickness different than the interior wall thickness. The outer skin may, in some embodiments, have a porosity different than that of the interior walls, e.g., can be made of a different material or can be made of the same material with a higher or lower porosity. In various exemplary embodiments, the skin may be extruded and/or molded together with the core of the honeycomb. In other exemplary embodiments, the skin may be a separate structure wrapped around the outside of the core and fired together with the core to create a ceramic structure.

According to certain non-limiting embodiments, the fired ceramic body can have a median pore size (d₅₀) of less than about 30 microns, such as ranging from about 8 microns to about 30 microns, from about 10 microns to about 25 microns, or from about 15 microns to about 20 microns, including all ranges and subranges in between, e.g., about 8, 9, 10, 11, 12, 13, 14, 15, 16, 17, 18, 19, 20, 21, 22, 23, 24, 25, 26, 27, 28, 29, or 30 microns. For instance, the d₅₀ value can range from about 12 microns to about 23 microns, such as from about 13 microns to about 22 microns, from about 14 microns to about 21 microns, from about 15 microns to about 20 microns, from about 16 microns to about 19 microns, or from about 17 microns to about 18 microns, including all ranges and subranges therebetween. As used herein, median pore sizes are measured via mercury porosimetry.

Additionally, in some embodiments, it may be desirable to limit the number of larger pores in the ceramic body, e.g., such that pores greater than 30 microns make up less than about 10% of the total porosity (d₉₀=30 microns). For example, pores greater than 30 microns may make up less than about 8%, less than about 5%, or less than about 2% of the total porosity. In various embodiments, the d₉₀ value can range from about 20 microns to about 50 microns, such as from about 25 microns to about 40 microns, or from about 30 microns to about 35 microns, including all ranges and subranges therebetween. Similarly, according to certain embodiments, it may be desirable to limit the number of smaller pores in the ceramic body, e.g., such that pores less than 5 microns make up less than about 10% of the total porosity (d₁₀=5 microns). For example, pores smaller than 5 microns may make up less than about 8%, less than about 5%, or less than about 2% of the total porosity. In various embodiments, the d₁₀ value can range from about 3 microns to about 15 microns, such as from about 4 microns to about 14 microns, from about 5 microns to about 12 microns, from about 6 microns to about 11 microns, from about 7 microns to about 10 microns, or from about 8 microns to about 9 microns, including all ranges and subranges therebetween.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a channel” includes examples having one such “channel” or two or more such “channels” unless the context clearly indicates otherwise. Similarly, a “plurality” or an “array” is intended to denote two or more, such that an “array of channels” or a “plurality of channels” denotes two or more such channels.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All numerical values expressed herein are to be interpreted as including “about,” whether or not so stated, unless expressly indicated otherwise. It is further understood, however, that each numerical value recited is precisely contemplated as well, regardless of whether it is expressed as “about” that value. Thus, “a dimension less than 100 nm” and “a dimension less than about 100 nm” both include embodiments of “a dimension less than about 100 nm” as well as “a dimension less than 100 nm.”

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method comprising A+B+C include embodiments where a method consists of A+B+C, and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

A cordierite-forming inorganic powder mixture comprising, in weight percent of total inorganic components: 40.7 wt % talc, calcined clay 21.4 wt %, 11.9 wt % hydrous clay, 14.5 wt % HVA, 4.8 wt % alumina, and 6.8 wt % silica; methylcellulose (3.3 wt % as a superaddition to the inorganic components); deionized water (23 wt % as a superaddition to the inorganic components), and polyalphaolefin (6 wt %), were combined with one or more emulsifiers (except for comparative Example A1) listed in Table I below (where wt % is a super addition relative to the inorganic components) to form green ceramic batch mixtures.

TABLE I
Exemplary Batch Mixtures

| | |
|---|---|
| A1 | No emulsifiers (comparative) |
| A2 | 0.7 wt % stearic acid (E120); 0.3 wt % oleic acid (E213) |
| B1 | 1 wt % siloxane of formula (II) (n = 3) |
| B2 | 0.7% siloxane of formula (II) (n = 3); 0.3 wt % oleic acid |
| C | 1 wt % siloxane of formula (III) (n = 8; m = 10) |
| D | 0.7 wt % siloxane of formula (IV) (n = 9; p = 1); 0.3 wt % |
| | oleic acid |

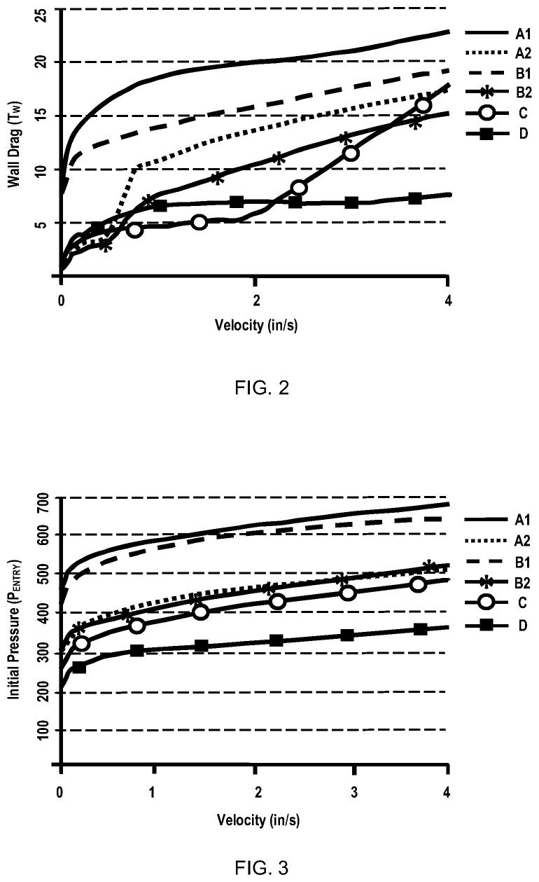

Capillary data for each of the green ceramic batch mixtures are illustrated in FIGS. 2-3, which graphically plot wall drag (T_{W}) and initial pressure (P_{entry}), respectively, as a function of extrusion velocity. As shown in FIG. 2-3, addition of a functionalized siloxane comprising hydroxyl groups as the emulsifier (batch B1) improves both the wall drag and initial pressure as compared to batch mixtures not comprising emulsifiers (batch A1). Further improvement can be achieved by adding oleic acid as a co-emulsifier (batch B2). Similar improvements were observed by adding a functionalized siloxane comprising carboxyl groups (batch C) as compared to batch mixtures not comprising emulsifiers (batch A1). Batch C also outperformed batch A2 comprising a combination of stearic and oleic fatty acids as emulsifiers. Finally, batch mixtures comprising a functionalized siloxane comprising hydroxyl-terminated ethoxide groups (batch D) exhibited improvement of both wall drag and initial pressure across the entire range of tested extrusion velocities as compared to batch mixtures comprising no emulsifiers (batch A1). Improvement was also observed by substituting both fatty acids in batch A2 with a weight equivalent of a functionalized siloxane comprising hydroxyl-terminated ethoxide groups (batch D).

1. A green ceramic batch mixture comprising:
at least one inorganic batch component;
at least one organic binder; and
an inverse emulsion comprising at least one lubricant, at least one aqueous solvent, and at least one functionalized silicone compound.

2. The batch mixture of claim 1, wherein the at least one inorganic batch component comprises a cordierite-forming powder.

3. The batch mixture of claim 1, wherein the at least one organic binder comprises a cellulosic binder.

4. The batch mixture of claim 1, wherein the at least one lubricant is chosen from mineral oils, poly alpha-olefin oils, and combinations thereof.

5. The batch mixture of claim 1, wherein the at least one aqueous solvent is water.

6. The batch mixture of claim 1, wherein the at least one functionalized silicone compound comprises at least one functional group chosen from a hydroxyl group, a carboxyl group, hydroxyl-terminated ethylene oxide groups, and combinations thereof.

7. The batch mixture of claim 1, wherein the at least one functionalized silicone compound comprises a functionalized siloxane.

8. The batch mixture of claim 1, further comprising at least one auxiliary emulsifier chosen from fatty acids, surfactants, and combinations thereof.

9. The batch mixture of claim 1, wherein the at least one aqueous solvent is present in the inverse emulsion in an amount ranging from about 75% to about 95% by weight based on the total weight of the inverse emulsion.

10. A green ceramic body comprising the batch mixture of claim 1.

11. A method for producing a ceramic body, comprising:
mixing batch materials to form a green ceramic batch mixture, wherein the batch materials comprise at least one inorganic batch component, at least one organic binder, at least one lubricant, at least one aqueous solvent, and at least one functionalized silicone compound; and
forming an inverse emulsion in the green ceramic batch mixture, the inverse emulsion comprising the at least one lubricant, the at least one aqueous solvent, and the at least one functionalized silicone compound; and
extruding the green ceramic batch mixture to form a green ceramic body.

12. The method of claim 11, further comprising pre-mixing the at least one lubricant, the at least one aqueous solvent, and the at least one functionalized silicone compound to form the inverse emulsion and mixing the inverse emulsion with the at least one inorganic batch component and the at least one organic binder.

13. The method of claim 11, wherein forming the inverse emulsion occurs during mixing of the batch materials.

14. The method of claim 11, wherein the batch materials further comprise at least one auxiliary emulsifier chosen from fatty acids, surfactants, and combinations thereof.

15. The method of claim 11, further comprising firing the green ceramic body.

16. A green ceramic body formed by the method of claim 11 or a fired ceramic body formed by the method of claim 15.

17. A green ceramic batch mixture comprising:
at least one inorganic batch component;
at least one organic binder; and
an inverse emulsion comprising at least one lubricant, at least one emulsifier, and at least 75% by weight of at least one aqueous solvent.

18. The batch mixture of claim 17, wherein the at least one emulsifier is chosen from fatty acids, surfactants, functionalized silicone compounds, and mixtures thereof.

19. The batch mixture of claim 17, wherein the at least one emulsifier is present in an amount ranging from about 0.1% to about 3% by weight relative to the total weight of the batch mixture.

20. A method for producing a ceramic body, comprising:
mixing batch materials to form a green ceramic batch mixture, wherein the batch materials comprise at least one inorganic batch component, at least one organic binder, at least one lubricant, at least one aqueous solvent, and at least one emulsifier; and
forming an inverse emulsion in the green ceramic batch mixture, the inverse emulsion comprising the at least one lubricant, the at least one aqueous solvent, and the at least one emulsifier, wherein the at least one aqueous solvent comprises at least about 75% by weight of the inverse emulsion; and
extruding the green ceramic batch mixture to form a green ceramic body.
